(19) United States
(12) Patent Application Publication
(10) Pub. No.: US 2023/0249731 A1
(43) Pub. Date: Aug. 10, 2023

(54) Cylinder Lifting Device

(71) Applicants: Hector Villarreal, Aurora, IL (US); Maynard F. Klotz, Naperville, IL (US)

(72) Inventors: Hector Villarreal, Aurora, IL (US); Maynard F. Klotz, Naperville, IL (US)

(21) Appl. No.: 18/093,285

(22) Filed: Jan. 4, 2023

Related U.S. Application Data
(60) Provisional application No. 63/296,321, filed on Jan. 4, 2022.

(51) Int. Cl. B62B 3/06; B62B 3/10

(52) U.S. Cl. CPC B62B 3/0618; B62B 3/104; B62B 2202/022; B62B 2203/10

(57) ABSTRACT

A gas cylinder lifting and transport device, includes a base supported on a plurality of wheels; a source of power; a lifting device carried on the base; a clamping apparatus having actuators that receives power from the source of power, to clamp or unclamp a gas cylinder. The actuators can be pneumatic cylinders and the source of power can be an on-board battery-operated compressor supported from the base, the compressor being flow connected to the pneumatic cylinders. Alternatively, the source of power can be a battery and the actuators can be electrically actuated linear actuators. The lifting device can be a manually operated lever or a powered lifting device such as an electric linear actuator or a pressurized fluid.

This application claims the benefit of U.S. Provisional Patent App. Ser. No. 63/296,321, filed Jan. 4, 2022.

### BACKGROUND

Different devices are known to move gas cylinders. U.S. Pat. No. 1,429,432 discloses a dolly with a flexible band used to secure a cylinder to a rectangular frame.

U.S. Pat. No. 2,477,294 discloses a dolly that uses a circular hinged band to secure an article such as an oxygen bottle. U.S. Pat. No. 2,654,493 describes an oxygen tank dolly consisting of a frame having vertical side bars and a top mounted handle bar with a tank receiving saddle secured to the lower ends of the bars. U.S. Pat. No. 4,205,937 describes a dolly for moving cylinders.

U.S. Pat. Nos. 6,554,300 and 6,799,769 disclose a dolly for loading, unloading, and transporting cylindrical objects to alternate locations. The dolly includes an adjustable restraining strap secured to one end of a cross member and includes a free end with an attachment member such that the strap may encircle the cylindrical object and be fastened to the opposing end of the cross member and tightened.

In each of these prior art patents the dolly requires an encircling band to hold a cylinder.

The present inventors have recognized the desirability to provide a gas cylinder moving apparatus that did not rely on a manually applied encircling band and which quickly and effectively lifts and moves a gas cylinder.

### SUMMARY

Exemplary embodiments of the present invention effectively lift and move cylinders, such as gas cylinders. The embodiments can be used to lift, move, load and unload cylinders into gas packs or to move cylinders within a facility.

An exemplary embodiment comprises a gas cylinder movement device that includes a powered clamp supported on a rolling platform. The platform can include a lever arrangement that can be manually operated to lift the powered clamp with the clamped gas cylinder for loading, unloading and transport of the gas cylinder. Alternatively, the lever can be replaced by a powered lifting device such as an electric linear actuator, a fluid or an air operated cylinder or similar device.

The powered clamp can be powered by an on-board power source such as a battery. The battery powers an air compressor to actuate pneumatic cylinders, or powers an on-board hydraulic pump that actuates hydraulic cylinders, or powers electrically actuated linear operators.

Alternately to “on-board” power sources, the clamp actuators can be powered by a remote power source via tubes or electrical cables.

One exemplary embodiment provides a cylinder lifting device that includes a base or platform supported on a plurality of wheels; a source of power; at least one column extending vertically from the base; a clamping apparatus; a lever bar pivotally attached at a first end to the clamping apparatus and having a handle portion at an opposite, second end, and pivotally connected to the at least one column at a position between the first and second ends; and the clamping apparatus having at least one actuator that receives power from the source of power, to clamp or unclamp a cylinder.

The source of power can be a pressurized fluid source and the at least one actuator can be a pneumatic or hydraulic cylinder that receives pressurized fluid from the pressurized fluid source to expand to clamp the cylinder.

The pressurized fluid source can be a compressor supported from the base and the pressurized fluid comprises air, the pneumatic or hydraulic cylinder being a pneumatic cylinder and the compressor being flow connected to the pneumatic cylinder.

The compressor can be flow-connected to an air tank and a battery powered electric motor drives the compressor.

The clamping apparatus can include a vertical bracket and first and second clamping structures carried by the vertical bracket. The first clamping structure can be fixed to the vertical bracket and the second clamping structure can be pivotally attached to the vertical bracket. The clamping structures can have arcuate engagement surfaces that face opposite sides of a cylinder to be clamped and wherein the at least one actuator can be connected between the first and second clamping structures.

The arcuate engagement surfaces of the first and second clamping structures can each comprise an upper curved plate and a lower curved plate on respective upper and lower ends of each clamping structure and a plurality of vertical slats connected between the upper and lower curved plates.

Another embodiment of the present invention replaces the pneumatic or hydraulic cylinders with electrically driven actuators to open and close the clamping apparatus and relaces the manually operated lever with an electric motor driven lifting device or lifting jack that lifts the clamping apparatus vertically on a guide column. An on-board battery delivers power to power a lifting motor of the lifting device and the electrically driven actuators. Alternatively, a cord connected to an external power source could be used instead of an on-board battery. power source.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a right-side perspective view of an exemplary embodiment apparatus of the present invention;

FIG. 2 is a left-side perspective view of the embodiment shown in FIG. 1;

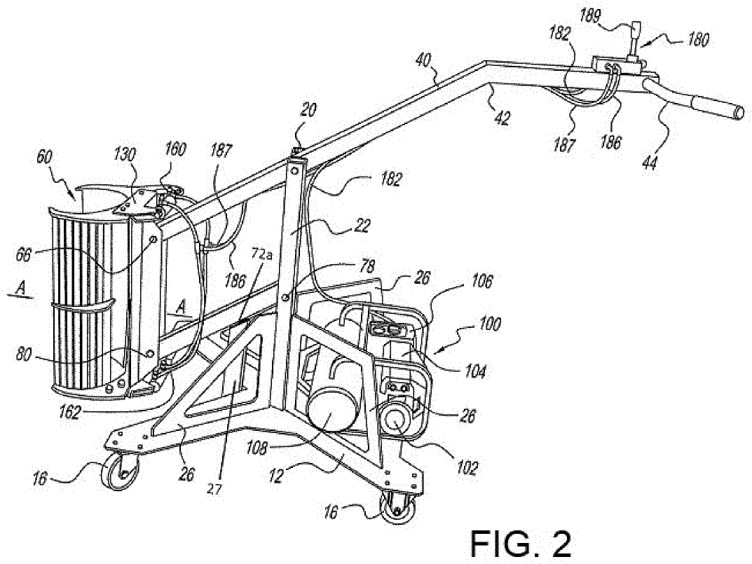

FIG. 3 is a left-side perspective view of the embodiment shown in FIG. 1 in a first stage of operation;

FIG. 4 is an enlarged, fragmentary perspective view taken from FIG. 3:

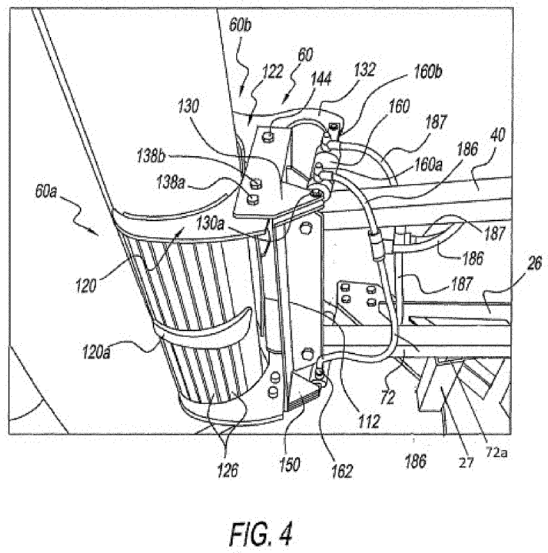

FIG. 5 is an enlarged left-side perspective view of the embodiment of FIG. 1 in a second stage of operation;

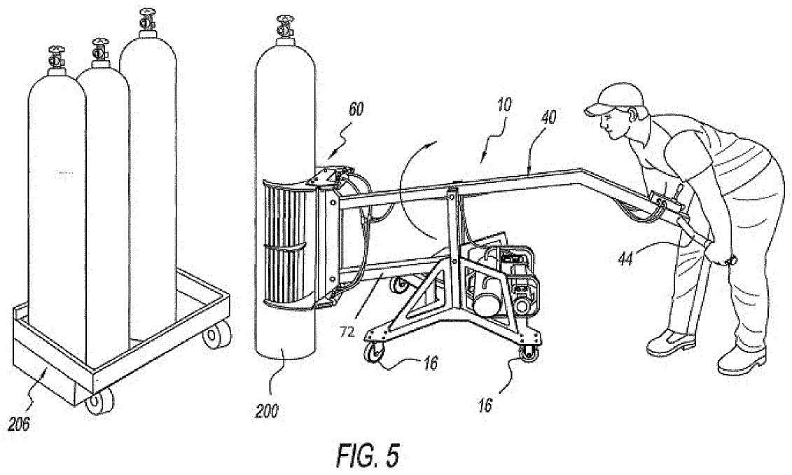

FIG. 6 is a right-side perspective view of an alternate embodiment apparatus of the present invention;

FIG. 7 is a right-side view of the embodiment of FIG. 6;

FIG. 8 is a right-side perspective view of a portion of the apparatus of FIG. 6 with some components removed to see otherwise hidden components;

FIG. 9 is an elevational view of the portion shown in FIG. 8;

FIG. 10 is a right-side perspective view of another portion of the apparatus of FIG. 6 with some components removed to see otherwise hidden components; and

FIG. 11 is a fragmentary sectional view taken generally through plane 11-11 of FIG. 6.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

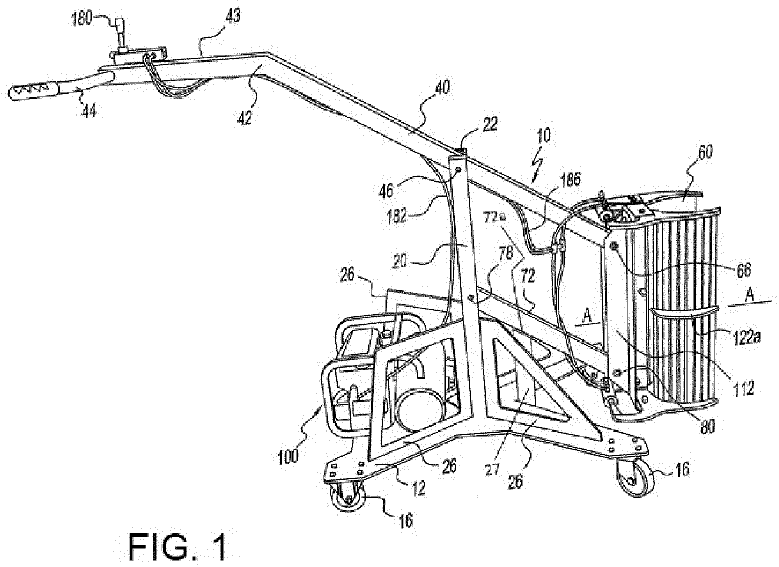

FIG. 1 illustrates a gas cylinder lifting apparatus 10. The apparatus includes a base 12 mounted on caster wheels 16. Parallel columns 20, 22 are attached to, and extend from, the base 12. Braces 26, in the form of open frames, make rigid the connection between the columns 20, 22 and the base 12. A lever bar 40 is fit between the columns 20, 22 and is pivotally attached by a pin 46 or other pivotal connection to the columns 20, 22. The lever bar 40 is bent at an inflection 42 into an extension bar 43 which mounts handlebars 44. A column 27, such as a square tube column, is welded or otherwise fastened to the base 12 and has a free top end that acts as a limit or stop to the downward movement of the support bar 72. The free top end of the column 27 interferes with a bottom surface of the support bar 72 at a mutual interface 72a. The column 27 thus also acts as a stop that defines the lowest position of the clamp apparatus 60.

At an end of the lever bar 40 opposite to the handlebars 44 is a clamping apparatus 60. The clamping apparatus 60 has a vertical bracket 112 having parallel walls that is attached to the lever bar 40 by the bar 40 being fit between the parallel walls and connected by an upper pin 66 or other pivotal connection to the parallel walls. The bracket 112 is also attached to a support bar 72 by the support bar 72 being fit between the parallel walls and being connected by a lower pin 80 or other pivotal connection to the parallel walls. The support bar 72 is attached at an opposite end to the columns 20, 22 by being fit between the columns 20, 22 and a pin 78 or other pivotal connection to the parallel columns 20, 22.

A portion of the lever bar 40, a portion of the columns 20, 22, the vertical bracket 112 and the support bar form a four-bar linkage, wherein during movement up or down of the clamped cylinder, the clamped cylinder remains substantially vertical.

A battery driven air compressor 100 is carried by the base 12. The air compressor includes an electric motor 102 driven by a battery pack 104. The motor drives a compressor 106 that delivers compressed air to an air tank 108. The air tank 108 delivers compressed air to a pneumatic switch 180 via a hose 182. The pneumatic switch 180 has two hoses 186, 187 which can be a pressure air hose and a vent hose respectively, or can be alternately a pressure air delivery hose or an air vent hose depending on the position of the switch handle 189. In the former case the pneumatic cylinders are moved by air pressure into a clamping position, and for release, the pneumatic cylinder is vented and the clamp is loosed or has a spring return. In the latter case the clamp is moved by pneumatic cylinders in both the clamped direction and the unclamped direction by air pressure on one side of the pistons within the pneumatic cylinders and a venting on an opposite side of the pistons within the pneumatic cylinders. To move in an opposite direction, the pressure air supply and the venting path are reversed with regard to the sides of the pistons within the pneumatic cylinders, i.e., the movement in either direction is a powered movement. The hose 186 is routed to two corresponding nozzles on the pneumatic cylinders 160, 162. The hose 187 is routed to two corresponding remaining nozzles on the cylinders 160, 162. Both pneumatic cylinders are either expanded or contracted together, to clamp or unclamp the clamping apparatus 60 depending on the position of the switch handle 189.

The clamping apparatus 60 has a configuration that is mirror image identical across a horizontal center plane “A.” Only a description of the upper portion of the apparatus 60 is described herein, with the understanding that the lower portion of the configuration is mirror image identical, i.e., the apparatus 60 includes the same components, configured and connected the same way, but in mirror image fashion.

The clamping apparatus 60 includes a left-side clamping structure 60a and a right-side clamping structure 60b. The left-side clamping structure 60a includes an upper left curved bracket 120, and a corresponding lower left curved bracket directly below. The right-side clamping structure 60b includes an upper right curved bracket 122, and a corresponding lower right curved bracket directly below. An upper bracket 130, and a corresponding lower bracket directly below, are fixedly connected to the vertical support bracket 112.

The upper left curved bracket 120 is fixed to the bracket 130 by fasteners 138a, 138b. The upper right curved bracket 122 includes a rearward extending portion 132. The bracket 122 is connected to the upper bracket 130 by a pin 144 or other pivotal connection that allows relative rotation between the bracket 130 and the upper right curved bracket 122 about a vertical axis of the pin 144. The apparatus 60 includes an upper pneumatic cylinder 160 that can expand or contract in length depending on the relative pressure delivered to nozzles 160a, 160b which deliver air to opposite sides of a piston within the pneumatic cylinder 160, and a mirror image lower pneumatic cylinder 162 directly below. One end of the pneumatic cylinder 160 is pivotally connected to a rearward protruding end 130a of the upper bracket 130. An opposite end of the pneumatic cylinder 160 is pivotally connected to the extending portion 132 of the upper right curved bracket 122. When the pneumatic cylinder 160 expands, the upper right side curved bracket 122 pivots about the pin 144 to pivot the right-side clamping structure 60b toward the left-side clamping structure 60a to close the clamp apparatus 60. When the pneumatic cylinder contracts, the upper right curved bracket pivots about the pin 144 to pivot the right-side clamping structure 60b away from the left-side clamping structure 60a to open the clamp apparatus 60.

On the left-side clamping structure 60a closely spaced metal slats are connected to and extend vertically between the upper left curved bracket 120 and a corresponding lower left curved bracket. An intermediate brace 120a can also be used to make rigid the slats between ends thereof. The slats 126 are arranged side by side along an arc forming a cylinder-engagement surface that corresponds to the outer circumference of a cylinder to be clamped. A resilient material can cover the slats for contact with the gas cylinder.

On the right-side clamping structure 60b closely spaced metal slats are connected to and extend vertically between the upper right curved bracket 122 and a corresponding lower right curved bracket. An intermediate brace 122a can also be used to make rigid the slats between ends thereof. The slats 126 are arranged side by side along an arc forming a cylinder-engagement surface that corresponds to the outer circumference of a cylinder to be clamped. A resilient material can cover the slats for contact with the gas cylinder.

When the pneumatic cylinders expand, the upper right curved bracket 122 and corresponding lower right curved bracket will pivot about pin 144, and a corresponding lower pin, to clamp a cylinder, such as a gas cylinder, between the slats 126 of the left-side clamping structure 60a and slats of the right-side clamping structure 60b.

When the pneumatic cylinders contract, the upper right curved bracket 122 and corresponding lower right curved bracket will pivot about pin 144, and a corresponding lower pin, to release a cylinder otherwise clamped between the slats 126 of the left-side clamping structure 60a and slats of the right-side clamping structure 60b.

The hoses 186, 187 are each flow connected to corresponding nozzles of both pneumatic cylinders 160, 162. Accordingly, the upper pneumatic cylinder 160 and the lower pneumatic cylinder 162 operate together and expand or contract together.

Once the clamp apparatus 60 clamps a cylinder, such as a gas cylinder 200, the handlebars can be pushed down to pivot the lever bar 40 and lift the cylinder 200 to remove the cylinder 200 from the cart 206.

The apparatus can be composed substantially of metal parts, and connection between components can be done by fasteners, welding or other known connections.

The vertical length of the left and right-side clamping structures 60a, 60b can be 2-3 feet to effectively clamp a gas cylinder although other vertical lengths are encompassed by the invention. The arcuate extent of the engagement surfaces provided by the slats of the left and right-side clamping structures can be such as to clamp past the half the circumference of the gas cylinder to assure effective clamping.

Although the illustrated embodiment describes a battery powered air compressor that actuates pneumatic cylinders, other types of fluid powered actuators are encompassed by the invention such as a motor-powered hydraulic oil pump that actuated hydraulic cylinders. Alternately the fluid powered actuators can be replaced by electric linear actuators and the compressor or hydraulic pump would not be used. An on-board battery could power the electric linear actuators.

Also, although an on-board battery powered pneumatic system is shown, other types of powered clamp systems can be used such as ones in which the motive power for the clamp actuators is not “on-board.” For example, if the clamp actuators are electrically driven linear actuators, they could be powered using an electrical cable plugged into an external source of electric power delivering electric power to the apparatus 10. Alternately, for fluid powered clamp actuators, the pressurized fluid can be delivered to the apparatus via a tube receiving pressurized fluid from an external source.

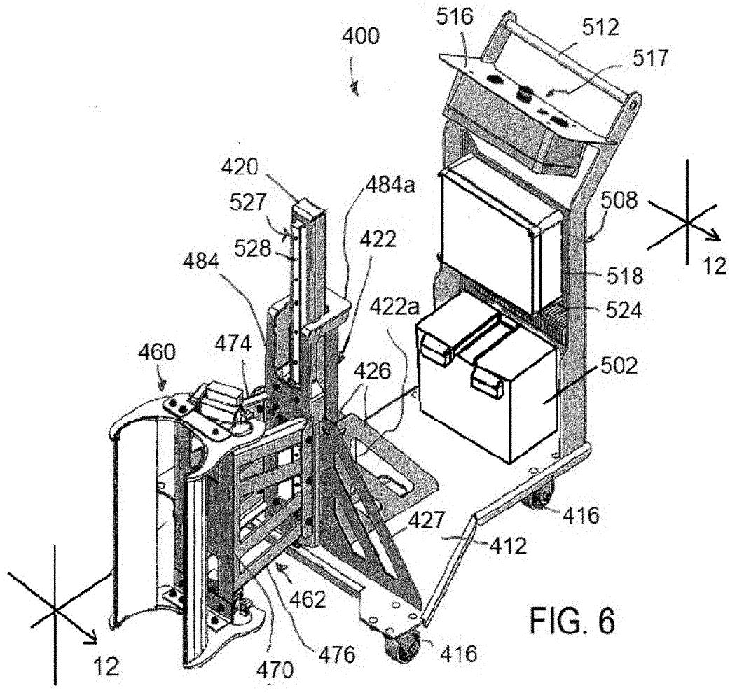

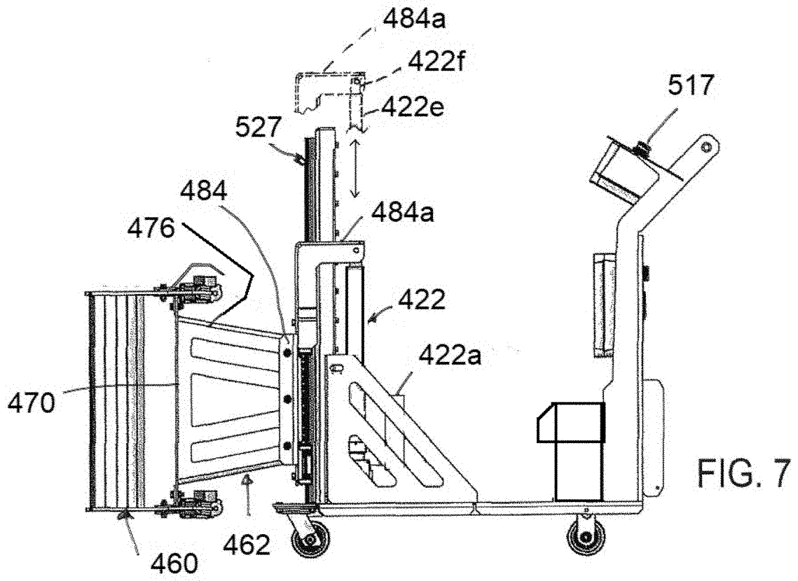

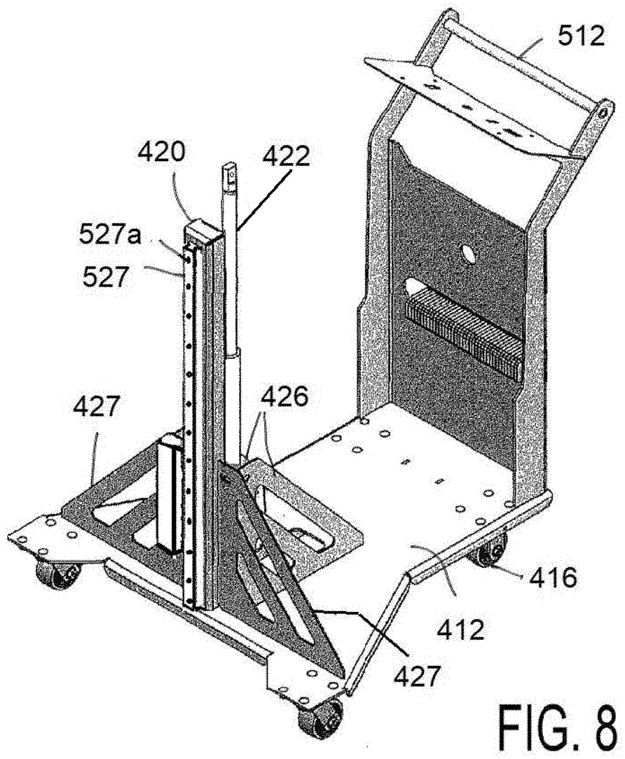

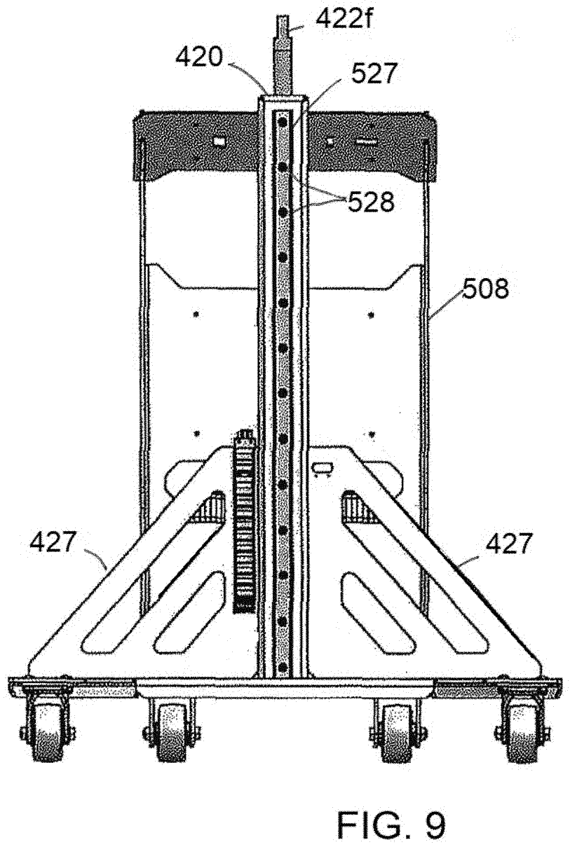

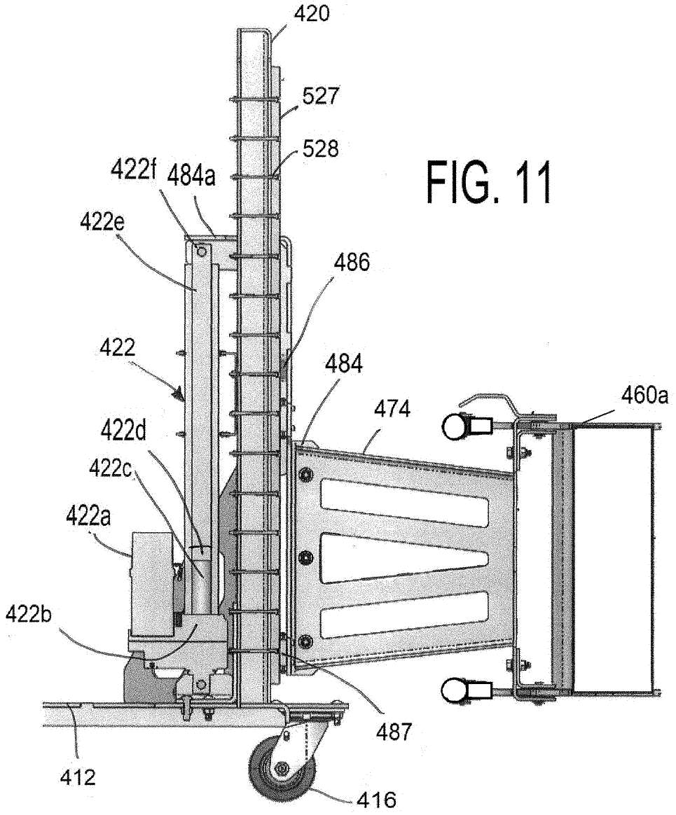

FIGS. 6-11 illustrate an alternate gas cylinder lifting apparatus 400. The apparatus has the same attributes as the apparatus 10 except for the differences described below. The apparatus includes a base or platform 412 mounted on caster wheels 416. A guide support column 420, and a lifting device 422 extend vertically from the base 412. Longitudinal braces 426, and lateral braces 427 in the form of open frames, make rigid the connection between the column 420, and the lifting device 422 and the base 412.

The lifting device 422 can be an electric telescopic linear actuator such as described in U.S. Pat. No. 4,790,201, herein incorporated by reference. As shown in FIG. 12, an electric motor 422a is configured and powered to cause rotation of gears in a gearbox 422b which rotates a vertically arranged threaded rod 422c. The threaded rod is engaged to a threaded nut 422d which is connected to a coaxially arranged hollow tube 422e on top of which mounts a lug 422f. Rotation of the threaded rod by the motor and gearbox causes the nut to raise or lower on the threaded rod depending on the selected rotation direction of the motor, which causes the hollow tube and lug to raise and lower as well. Other forms of electric linear actuators are also encompassed by the invention.

As shown in FIG. 6, a clamping apparatus 460 is guided for vertical movement by the guide support column 420, particularly by a guide rail 527 mounted to the column 420. The clamping apparatus 460 has a frame 462 having a front wall 470 and parallel wall frames 474, 476 that are attached to a rear frame 484. The rear frame is guided by the guide column 420 and vertically positioned by the lifting device 422.

The electric motor 422a is engaged to the lifting device to raise and lower the rear frame 484 and thus the entire clamping apparatus 460. A battery 502 is carried by the base 412. A handle frame 508 extends vertically from the base and includes a handle bar 512. A control panel 516 is mounted to the frame 508 adjacent to the handle bar 512. The control panel is signal connected to a control and power box 518, also mounted to the frame 512. Beneath the power box 518, mounted to the handle frame 508 are counterweight plates 524, which counter balance the front weight of the clamping apparatus 460 holding a cylinder. Controls 517 are provided on the panel 516 to actuate the clamping actuators 560, 562 to open or close the clamping apparatus 460 to clamp or release a cylinder, and to lift or lower the lifting device 422.

The rear frame 484 includes a rearwardly extended bracket 484a that is connected to the lug 422f of the lifting device.

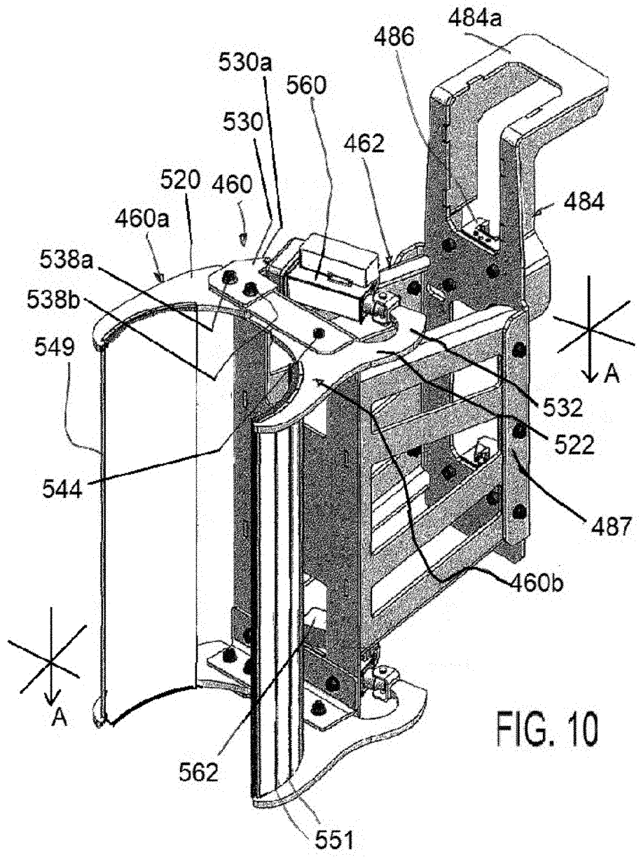

The guide rail 527 that has a dovetail cross-section 527a to be received in dovetail grooves 485 in identical upper and lower brackets 486, 487 that are fastened to a rear side of the rear frame 484 (see FIG. 10) which accommodates only vertical movement of the clamping apparatus on the guide rail 527. The guide rail is fastened by fasteners 528 to the guide support column 420. The dovetail grooves 485 in identical upper and lower brackets 486, 487 can also be configured to be slide bearings for smooth, reduced friction raising and lowering of the clamping apparatus 460 on the guide rail 527.

The clamping apparatus 460 has a configuration that is mirror image identical across a horizontal center plane “A.” Only a description of the upper portion of the apparatus 460 is described herein, with the understanding that the lower portion of the configuration is mirror image identical, i.e., the apparatus 460 includes the same components, configured and connected the same way, but in mirror image fashion.

The clamping apparatus 460 includes a left-side clamping structure 460a and a right-side clamping structure 460b. The left-side clamping structure 460a includes an upper left curved bracket 520, and a corresponding lower left curved bracket directly below. The right-side clamping structure 460b includes an upper right curved bracket 522, and a corresponding lower right curved bracket directly below. An upper bracket 530, and a corresponding lower bracket directly below, are fixedly connected to the rear frame 484.

The upper left curved bracket 520 is fixed to the bracket 530 by fasteners 538a, 538b. The upper right curved bracket 522 includes a rearward extending portion 532. The bracket 522 is connected to the upper bracket 530 by a pin 544 or other pivotal connection that allows relative rotation between the bracket 530 and the upper right curved bracket 522 about a vertical axis of the pin 544. The apparatus 460 includes an upper electric linear actuator 560 that can expand or contract in length depending on the electric signal from the control panel, and a mirror image electric linear actuator 562 directly below. One end of the electric linear actuator 560 is pivotally connected to a rearward protruding end 530a of the upper bracket 530. An opposite end of the electric linear actuator 560 is pivotally connected to the extending portion 532 of the upper right curved bracket 522. When the electric linear actuator 560 expands, the upper right side curved bracket 522 pivots about the pin 544 to pivot the right-side clamping structure 460b toward the left-side clamping structure 460a to close the clamp apparatus 460. When the electric linear actuator contracts, the upper right curved bracket pivots about the pin 544 to pivot the right-side clamping structure 460b away from the left-side clamping structure 460a to open the clamp apparatus 460.

The linear actuators 560, 562 can be as described for the lifting device 422, that is, a motor drives a gearbox that drives a threaded rod that translates a nut threaded on the rod that moves a hollow rod to either expand the overall length of the linear actuator or contacts the overall length of the linear actuator depending on the selected direction of rotation of the motor.

On the left-side clamping structure 460a, closely spaced metal slats 549 are connected to and extend vertically between the upper left curved bracket 520 and a corresponding lower left curved bracket. The slats 549 are arranged side by side along an arc forming a cylinder-engagement surface that corresponds to the outer circumference of a cylinder to be clamped. A resilient material can cover the slats for contact with the gas cylinder.

On the right-side clamping structure 460b closely spaced metal slats 551 are connected to and extend vertically between the upper right curved bracket 522 and a corresponding lower right curved bracket. The slats 551 are arranged side by side along an arc forming a cylinder-engagement surface that corresponds to the outer circumference of a cylinder to be clamped. A resilient material can cover the slats for contact with the gas cylinder.

When the electric linear actuators 560, 562 expand, the upper right curved bracket 522 and corresponding lower right curved bracket will pivot about pin 544, and a corresponding lower pin, to clamp a cylinder, such as a gas cylinder, between the slats 549 of the left-side clamping structure 460a and slats 551 of the right-side clamping structure 460b.

When the electric linear actuators contract, the upper right curved bracket 522 and corresponding lower right curved bracket will pivot about pin 544, and corresponding lower pin, to release a cylinder otherwise clamped between the slats 549 of the left-side clamping structure 460a and slats 551 of the right-side clamping structure 460b.

The upper electric linear actuator 560 and the lower electric linear actuator 562 operate together and expand or contract together.

The battery is electrically connected to the signal and power box. The control panel is signal connected to the signal and power box. The controls 517 are used to send an appropriate electrical current and polarity to the lifting device motor 422a and to motors of the linear actuators 560, 562 to selectively raise or lower the clamping apparatus and to selectively clamp or unclamp a gas cylinder 200 by the clamping apparatus 460.

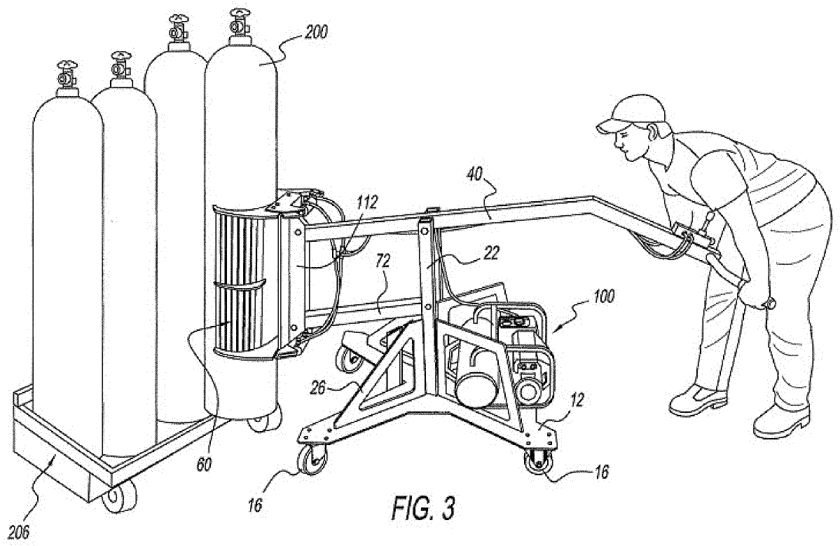

Once the clamp apparatus 460 clamps a cylinder, such as a gas cylinder 200, the electric motor 422a can be actuated by the controls 517 to lift the clamp frame 462 along the guide rail 527 and lift the cylinder 200 to remove the cylinder 200 from the cart 206 (see FIG. 3).

The apparatus can be composed substantially of metal parts, and connection between components can be done by fasteners, welding or other known connections.

The vertical length of the left and right-side clamping structures 460a, 460b can be 2-3 feet to effectively clamp a gas cylinder, although other vertical lengths are encompassed by the invention. The arcuate extent of the engagement surfaces provided by the slats of the left and right-side clamping structures can be such as to clamp past the half the circumference of the gas cylinder to assure effective clamping.

Also, although an on-board battery powered motor system is shown, other types of powered clamp systems can be used such as ones in which the motive power for the clamp actuators and lifting device is not “on-board.” For example, the electrically driven linear actuators and motor could be powered using an electrical cable plugged into an external source of electric power delivering electric power to the apparatus 400.

The cylinder lifting apparatus could also utilize a pneumatic or hydraulic lifting device for the clamping apparatus combined with pneumatic or hydraulic linear actuators for clamping a gas cylinder with the clamping apparatus; or utilize an electric lifting device for the clamping apparatus with pneumatic or hydraulic linear actuators for clamping a gas cylinder with the clamping apparatus; or a pneumatic or hydraulic lifting device for the clamping apparatus combined with electric linear actuators for clamping a gas cylinder with the clamping apparatus.

While the exemplary embodiments are particularly suited for lifting and transporting gas cylinders, the invention can encompass other embodiments for lifting and transporting other objects.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A gas cylinder lifting device, comprising:
a base supported on a plurality of wheels;
a source of power;
a clamping apparatus;
a lifting device to lift the clamping apparatus; and
the clamping apparatus having at least one actuator that receives power from the source of power, to clamp or unclamp a gas cylinder-to-be-clamped.

2. The gas cylinder lifting device of claim 1, wherein the source of power is a pressurized fluid source and the at least one actuator comprises a fluid-operated cylinder that receives pressurized fluid from the pressurized fluid source to expand to clamp the gas cylinder-to-be-clamped.

3. The gas cylinder lifting device of claim 2, wherein the pressurized fluid source comprises a compressor supported from the base and the pressurized fluid comprises air, the compressor flow connected to the fluid-operated cylinder.

4. The gas cylinder lifting device according to claim 3 wherein the pressurized fluid source comprises an air tank flow-connected to the compressor and a battery powered electric motor for driving the compressor.

5. The gas cylinder lifting device of claim 2, wherein the pressurized fluid comprises air.

6. The gas cylinder lifting device according to claim 1, wherein the clamping apparatus comprises a vertical bracket and first and second clamping structures carried by the vertical bracket, the first clamping structure fixed to the vertical bracket and the second clamping structure pivotally attached to the vertical bracket, the clamping structures having arcuate engagement surfaces that face opposite sides of a gas cylinder- to-be-clamped and wherein the at least one actuator is connected between the first and second clamping structures.

7. The gas cylinder lifting device of claim 6, wherein the arcuate engagement surfaces of the first and second clamping structures each comprise an upper curved plate and a lower curved plate on respective upper and lower ends of each clamping structure and a plurality of vertical slats connected between the upper and lower curved plates.

8. The gas cylinder lifting device according to claim 1, wherein the lifting device is powered.

9. The gas cylinder lifting device according to claim 8, wherein the lifting device comprises a motor operated lifting device connected to the clamping apparatus and comprising a guide column guiding the vertical movement of the clamping apparatus.

10. The gas cylinder lifting device according to claim 8, wherein the lifting device comprises a pressurized fluid operating cylinder connected to the clamping apparatus and comprising a guide column guiding the vertical movement of the clamping apparatus.

11. The gas cylinder lifting device according to claim 1, wherein the lifting device comprises a lever that is manually operated to pivot the clamping apparatus.

12. A gas cylinder lifting device, comprising:
a base supported on a plurality of wheels;
a source of pressurized fluid;
at least one column extending vertically from the base;
a clamping apparatus;
a lever bar pivotally attached at a first end to the clamping apparatus and having a handle at an opposite, second end, and pivotally connected to the column at position between the first and second ends;
the clamping apparatus having at least one fluid-operated cylinder that receives pressurized fluid from the source of pressurized fluid to expand to close the clamping apparatus, to clamp a gas cylinder-to-be-clamped.

13. The gas cylinder lifting device of claim 12, wherein the source of pressurized fluid comprises a battery powered air compressor carried on the base and the pressurized fluid is air.

14. The gas cylinder lifting device according to claim 12, comprising a fluid switch connected to the at least one fluid-operated cylinder, the position of the fluid switch either expanding or contracting the fluid-operated cylinder.

15. The gas cylinder lifting device according to claim 12, wherein the clamping apparatus comprises a vertical bracket and first and second clamping structures carried by the vertical bracket, the first clamping structure fixed to the vertical bracket and the second clamping structure pivotally attached to the vertical bracket, the clamping structures having arcuate engagement surfaces that face opposite sides of a gas cylinder-to-be-clamped and wherein the at least one fluid-operated cylinder is connected between the first and second clamping structures.

16. The gas cylinder lifting device of claim 15, wherein the arcuate engagement surfaces of the first and second clamping structures each comprise an upper curved plate and a lower curved plate on respective upper and lower ends of each clamping structure and a plurality of vertical slats connected between the upper and lower curved plates.

17. A gas cylinder lifting device, comprising:
a base supported on a plurality of wheels;
a source of power;
at least one column extending vertically from the base;
a clamping apparatus;
a lifting device for moving the clamping apparatus along the column; and
the clamping apparatus having at least one actuator that receives power from the source of power, to clamp or unclamp a gas cylinder-to-be-clamped.

18. The gas cylinder lifting device of claim 17, wherein the source of power is a pressurized fluid source and the at least one actuator comprises a fluid-operated cylinder that receives pressurized fluid from the pressurized fluid source to expand to clamp the cylinder-to-be-clamped.

19. The gas cylinder lifting device according to claim 17, wherein the clamping apparatus comprises a vertical bracket and first and second clamping structures carried by the vertical bracket, the first clamping structure fixed to the vertical bracket and the second clamping structure pivotally attached to the vertical bracket, the clamping structures having arcuate engagement surfaces that face opposite sides of a gas cylinder- to-be-clamped and wherein the at least one actuator is connected between the first and second clamping structures.

20. The gas cylinder lifting device according to claim 17, wherein the source of power is a source of electric power and the at least one actuator comprises an electric linear actuator that can be energized to expand and cause the clamping apparatus to grip a gas cylinder.

21. A portable lifting device, comprising:
a base supported on a plurality of wheels;
a source of power carried by the base;
a clamping apparatus carried by the base;
a lifting device carried on the base to lift the clamping apparatus; and
the clamping apparatus having at least one actuator that receives power from the source of power, to clamp or unclamp an object-to-be-clamped.

22. The portable lifting device, according to claim 21 wherein the at least one actuator is a linear actuator.

23. The portable lifting device, according to claim 22 wherein the lifting device comprises a linear actuator to selectively raise or lower the clamping apparatus.
